(19) United States
(12) Patent Application Publication
(10) Pub. No.: US 2006/0129444 A1
(43) Pub. Date: Jun. 15, 2006

(54) Appointment arbiter

(75) Inventors: Daniel Baeza, Coral Springs, FL (US); Robert A. Koch, Norcross, GA (US); Jennifer Pearson Medlin, Atlanta, GA (US); Robert J. Starr, Decatur, GA (US); Samuel N. Zellner, Dunwoody, GA (US)

Correspondence Address: THOMAS, KAYDEN, HORSTEMEYER & RISLEY, LLP/;BELLSOUTH I.P. CORP, 100 GALLERIA PARKWAY, SUITE 1750, ATLANTA, GA, 30339, US

(73) Assignee: BellSouth Intellectual Property Corporation

(21) Appl. No.: 11/013,564

(22) Filed: Dec. 15, 2004

(51) Int. Cl. G06F 9/46

(52) U.S. Cl. 705/8

(57) ABSTRACT

Embodiments of the present disclosure provide systems and methods for setting up an appointment. Briefly described, in architecture, one embodiment of the system, among others, can be implemented as follows. The system includes first logic configured to receive a request for establishing an appointment and second logic configured to establish an appointment between a party who sent the request and a subject described in the request, wherein the appointment is established after the appointment is unilaterally approved by the party who sent the request. Other systems and methods are also provided.

### TECHNICAL FIELD

The present disclosure is generally related to time management tools and, more particularly, is related to appointment schedulers.

### BACKGROUND

People use many types of tools to help manage their time, including personal time management tools, such as electronic calendars. Therefore, in the scheduling of a time or date for an appointment, the electronic calendars of the potential attendants of the meeting should be considered along with the person requesting the appointment. However, an electronic calendar does not necessarily take into account all of the restrictions on a person's time. Therefore, additional information may need to be considered in making an appointment. Further, conventional processes for setting up an appointment may often involve a lot of deliberation, consultation, and/or negotiations between the persons or parties involved in order to select a convenient date and time for an appointment. As such, a more efficient process for setting up appointments is needed. For example, one problem with efficiently scheduling appointments occurs when a potential attendant is not available to participate in setting up the appointment.

Thus, a heretofore unaddressed need exists in the industry to address the aforementioned deficiencies and inadequacies.

### SUMMARY

Embodiments of the present disclosure provide systems and methods for setting up an appointment. Briefly described, in architecture, one embodiment of the system, among others, can be implemented as follows. The system includes first logic configured to receive a request for establishing an appointment and second logic configured to establish an appointment between a party who sent the request and a subject described in the request, wherein the appointment is established after the appointment is unilaterally approved by the party who sent the request.

The present disclosure can also be viewed as providing methods for setting up an appointment. In this regard, one embodiment of such a method, among others, can be broadly summarized by the following steps: receiving a request, from a requesting party, for setting up an appointment with a subject, the request specifying a purpose of the appointment; selecting a time at which the receiving party and the subject have available for the appointment; restricting the subject from making another appointment at the selected time; prompting the requesting party to approve of the selected time; and upon receiving approval from the requesting party, obligating the subject to attend the selected appointment.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a block diagram of one embodiment, among others, of an appointment arbiter system for setting appointments of the present disclosure.

FIG. 2 is a flowchart describing the functionality of one embodiment, among others, of the electronic arbiter system of FIG. 1 when the first party makes a request for an appointment.

FIG. 3 is a diagram showing an appointment request message as utilized in the system of FIG. 1.

FIG. 4 is a diagram showing a message containing a suggested appointment as utilized in the system of FIG. 1.

FIG. 5 is a diagram showing a confirmation message of an accepted appointment as utilized in the system of FIG. 1.

FIG. 6 is a block diagram of an appointment arbiter system of FIG. 1 utilizing e-mail communication messages.

FIG. 7 is a diagram showing one embodiment, among others, of a contacts window interface as utilized in the system of FIG. 1 to create an appointment request.

FIG. 8 is a diagram showing a template for generating an appointment request within the system of FIG. 1.

FIG. 9 is a diagram showing one embodiment, among others, of the appointment arbiter system of FIG. 1 utilizing web-based communication messages.

FIG. 10 is a diagram showing one embodiment, among others, of a process for setting an appointment using the electronic calendars of both the party requesting the appointment and a subject of the appointment as utilized in FIG. 1.

FIGS. 11-12 are diagrams showing embodiments, among others, of a profile of a particular service provider and a profile 1200 of a requesting user, as utilized in the system of FIG. 1.

FIGS. 13-17 are diagrams showing one embodiment, among others, of web pages facilitating the creation of an appointment request to a referral service within the system of FIG. 1.

FIG. 18 is a flowchart describing one embodiment, among others, of a process for setting up an appointment by examining different sets of information that are pertinent to setting up the appointment within the system of FIG. 1.

FIG. 19 is a flowchart describing one embodiment, among others, of a process for setting up an appointment that imposes a penalty for missing the appointment within the system of FIG. 1.

FIG. 20 is a diagram showing one embodiment, among others, of an appointment request that may be composed using a communications device within the system of FIG. 1.

FIG. 21 is a diagram showing one embodiment, among others, of a notification message that is received by a user of a suggested appointment within the system of FIG. 1.

FIG. 22 is a diagram showing one embodiment, among others, of a confirmation message as utilized within the system of FIG. 1.

FIG. 23 is flowchart describing one embodiment, among others, of a process for imposing a financial penalty for missing a scheduled appointment within the system of FIG. 1.

### DETAILED DESCRIPTION

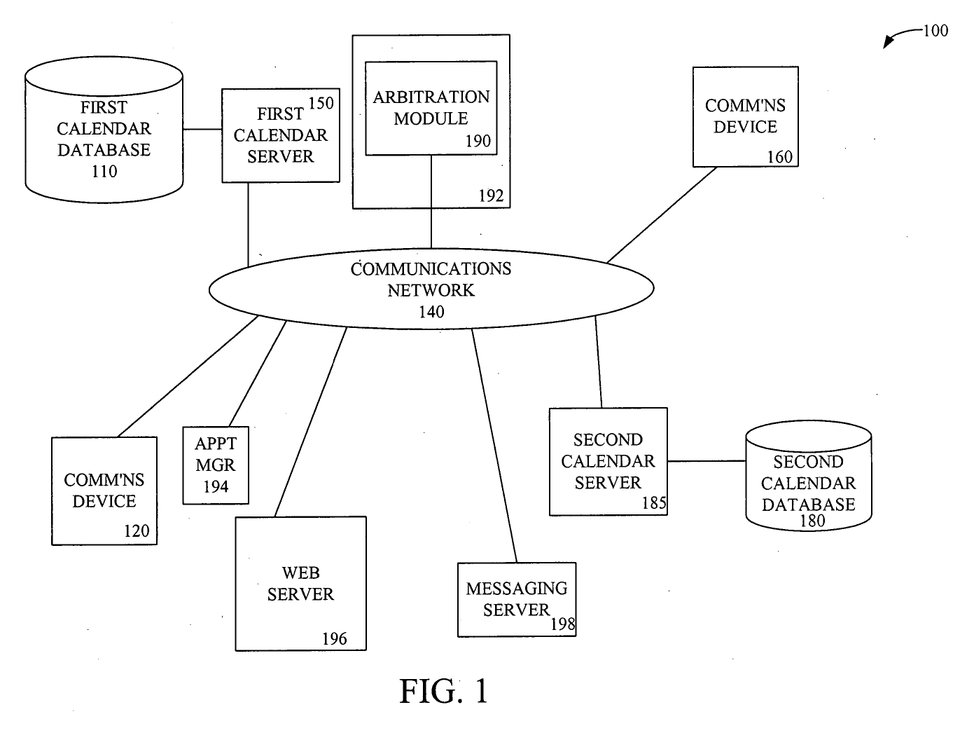

FIG. 1 is a block diagram of one embodiment, among others, of an appointment arbiter system for setting appointments of the present disclosure. As shown in FIG. 1, one embodiment 100 of the appointment arbiter system includes an electronic calendar of a first party that is stored in a first calendar database 110. According to an exemplary embodiment, the term “party” is not limited to a person but may also include some other entity, such as a resource. The electronic calendar enables a user (or some other entity) to record events, appointments, and notes for the user/entity. The first calendar database 110 storing the electronic calendar may be stored locally in a communications device 120 (e.g., personal communications device, a mobile phone, a personal digital assistant, a laptop, e-mail client, etc.) of the first party or in a remote or network location that can be accessed by the first party via the communications device 120 (e.g. web browser device, mobile phone, personal digital assistant, etc.) via a communications network 140, for example. The communications network 140 is a network of communication links that are arranged such that communication messages may be passed from one part of the network to another (using gateways such as a wireless data gateway, for example). Accordingly, one part of the communications network 140 may employ a different transmission system and/or communication protocols than another part. Further, more than one type of communication message may be transmitted from one part of the communications network 140 to another part. In the particular example shown in FIG. 1, the first calendar database 110 is at a network location and communicates with a first calendar server 150 that controls access to electronic calendar(s) in the first calendar database 110. As such, the first calendar database 110 may also contain electronic calendars of other users.

Accordingly, the appointment arbiter system 100, in some embodiments, also includes an electronic calendar of a second party. The electronic calendar of the second party also may be stored locally in a communications device 160 (e.g., personal communications device, a mobile phone, a personal digital assistant, a laptop, etc.) of a second party or in a remote or network location that can be accessed by the second party via the communications device 160 (e.g. web browser device, mobile phone, personal digital assistant, e-mail client, etc) of the second party. In some embodiments, the electronic calendars of the first party and the second party may be stored in a common database, such as the first calendar database 110. Also, in some embodiments, the electronic calendars of the first party and the second party may be stored in separate databases and accessed by different calendar servers. For example, in the example of FIG. 1, the electronic calendar of the second party is stored in a second calendar database 180 whose access is controlled by a second calendar server 185.

According to some embodiments, an arbitration module 190 may communicate and access electronic calendars from different calendar systems. For example, one embodiment of the appointment arbiter system 100 follows calendar standards provided by the Internet Calendaring and Scheduling Core Object Specification (vCalendar) to provide interoperability between different calendaring systems. In particular, the Internet Calendaring and Scheduling Core Object Specification (vCalendar) provides a definition of a common format for openly exchanging calendaring and scheduling information across the Internet. The vCalendar specification is defined by the Internet Engineering Steering Group (hereinafter referred to as “IESG”) in an iCalendar format. The IESG has approved the specification for iCalendar as proposed standards as outlined in the following Request for Comments as follows: RFC 2445, Internet Calendaring and Scheduling Core Object Specification (iCalendar), which is incorporated herein in its entirety; RFC 2446 iCalendar Transport-Independent Interoperability Protocol (iTIP): Scheduling Events, Busy Time, To-dos and Journal Entries which is incorporated herein in its entirety; RFC 2447, iCalendar Message-based lnteroperability protocol (iMIP) which is incorporated herein in its entirety; and RFC 3283 Guide to Internet Calendaring which is incorporated herein in its entirety. Therefore, components of the appointment arbiter system may communicate with each other and different calendar system regardless of whether the components are co-located in one location or are located at different parts of the communication network 140.

In addition to the electronic calendars, some embodiments of the appointment arbiter system 100 include electronic profiles of the first party and the second party. Information contained in an electronic profile of a user (or other entity) may be pertinent to setting up an appointment but also may not be contained in an electronic calendar of a user (or other entity) or in the appointment request itself. Profile information generally contains information associated with a user, such as his or her name, address, username & password to other servers, such as a calendar server, a credit card number, user-ID for profile, appointment configuration settings, telephone numbers of a user, e-mail address(es), pager address(s), insurance information, credit card information, etc. In addition, an electronic profile for an entity such as a conference room may include such information as the location of the room, contact information for an administrator associated with the room, etc. Electronic profiles may be created, in some embodiments, as part of a registration process for joining a service for facilitating the scheduling of appointments.

Referring back to FIG. 1, the arbitration module 190 communicates with the servers 150, 185 and/or databases 110, 180 storing the respective electronic calendars and also electronic profiles. In the representation shown in FIG. 1, the arbitration module 190 is located on a network server 192. However, in some embodiments, the arbitration module 190 may be located on the communications device 120, 160 of either the first party or the second party. In addition, some embodiments of the appointment arbiter system, the communications device 120 (such as an e-mail device, a web browser, etc.) may have the capability for sending and receiving communication messages, and for generating and responding to requests for setting up an appointment. The communications network 140 may also feature a web server 196 for providing web pages that facilitate the setting of appointments in the appointment arbiter system and a messaging server 198 for sending communications messages to communications devices 120, 160 or other messaging clients (not shown).

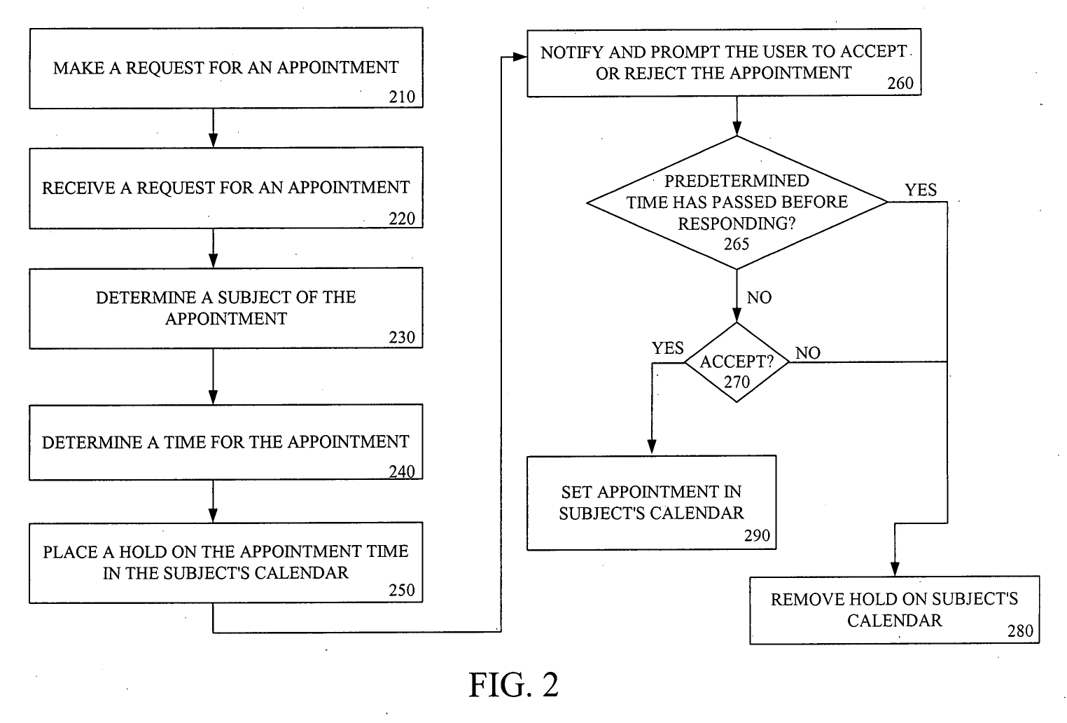

Next, the flowchart of FIG. 2 shows the functionality of one embodiment 200, among others, of the electronic arbiter system of FIG. 1 when the first party makes a request for an appointment that is to be set by the arbitration module 190. Accordingly, the first party utilizes a communications device 120 in order to make a request (210) for an appointment. In different embodiments, the communications device 120 may embody different types of messaging clients (e.g., e-mail client, short message service client, instant messaging client, telephony device, etc.). For example, in one embodiment, the first party may utilize an e-mail application to send an e-mail appointment request to the arbitration module 190. The arbitration module 190 then receives (220) and analyzes the request to determine (230) a subject of the appointment. The subject is the person or entity of which the requester of the appointment request desires to set up the appointment request. For example, a user may desire to set up an appointment with another user, such as a friend, his or her doctor, etc. Correspondingly, a user could also set up an appointment to reserve a room, use of a particular resource (such as audio/video equipment), etc. The identity of the subject may or may not be specified in the appointment request, for some embodiments.

Accordingly, for some embodiments, the arbitration module 190 determines and proposes a subject (e.g., appointment attendee, appointment entity (such as a particular conference room, etc.) to the first party making an appointment request. In addition to determining the appointment subject, the arbitration module 190 also determines (240) a time for the appointment. After determining a time for the appointment, the arbitration module 190 places (250) a hold on the suggested time on the subject's electronic calendar to prevent the subject from scheduling another event (appointment, reminder, etc.) for the suggested time. In this way, the suggested date and time for the appointment is temporarily reserved for the suggested appointment. Then, the arbitration module 190 notifies and prompts (260) the first party making the request to either accept the suggested appointment time or to reject the suggested appointment time within a predetermined amount of time. If the first party accepts (270) the suggested appointment time, the appointment is written or set (280) to the electronic calendar of the subject by the arbitration module 190. Note, acceptance of the appointment by the requestor can be automatic, as stated in a profile within the requestor's profile, or a parameter set in making the appointment request. Alternatively, if the first party rejects (270) the suggested appointment time or if the predetermined amount of time passes before the user responds (265), the hold on the suggested time is removed (290) from the electronic calendar of the subject by the arbitration module 190.

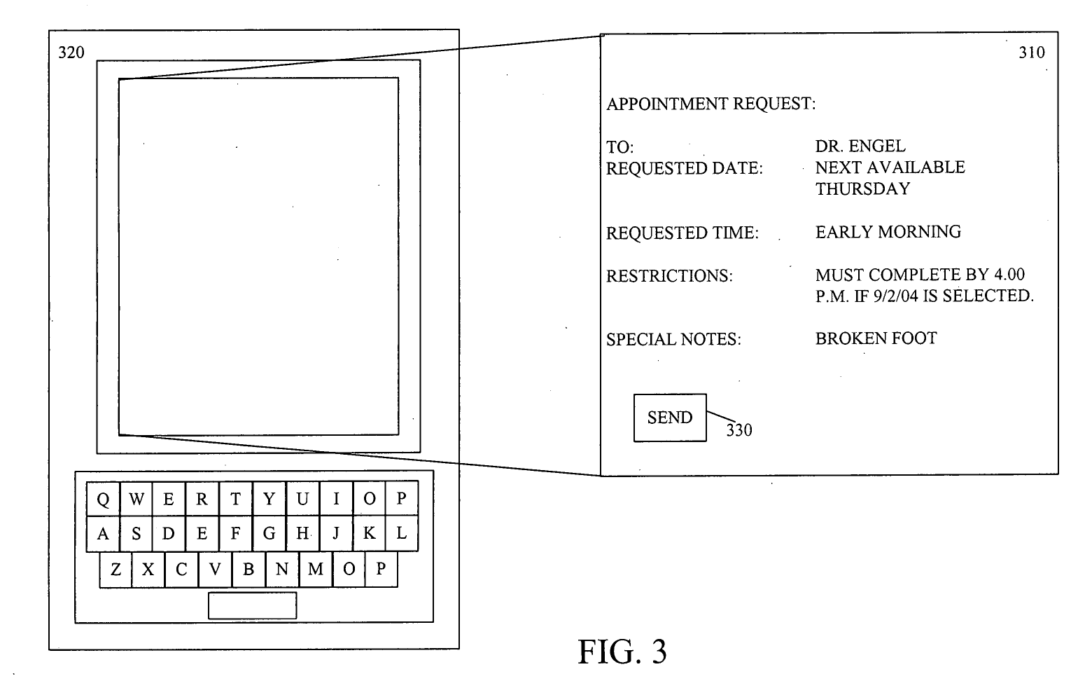

In some embodiments, the appointment request may be made by following a special format or language. For example, certain phrases and words from a set list that are understood or recognized by the arbitration module 190 may be utilized in the appointment request. For example, FIG. 3 shows a message 310 that may be constructed for one embodiment. Here, a user can type out the contents of a message on the communication device 320, such as a personal digital assistant. In the message shown in FIG. 3, a user specifies the subject of the appointment request to be “Dr. Engel.” In the appointment request, the user further provides the requested or desired date for setting up an appointment, for this example. In the message 310, the user specifies the date corresponding to the next available Thursday. However, the user may have also specified different dates, such as earliest available, September 2, as soon as possible, etc. In embodiments, where the arbitration module 190 is capable of accessing the electronic calendar of the user making the request, the user could also suggest a requested or desired date by specifying “the next available date that is good for me,” for example, whereby the arbitration module 190 would check the user's electronic calendar for the next available dates. In some embodiments, the user may receive an error message and be prompted to restate a phrase that is not recognized by the arbitration module 190. To send the appointment request, the user activates (e.g., click using a cursor) the send button 330 at the bottom of the message 310 being displayed by the personal digital assistant 320, for some embodiments.

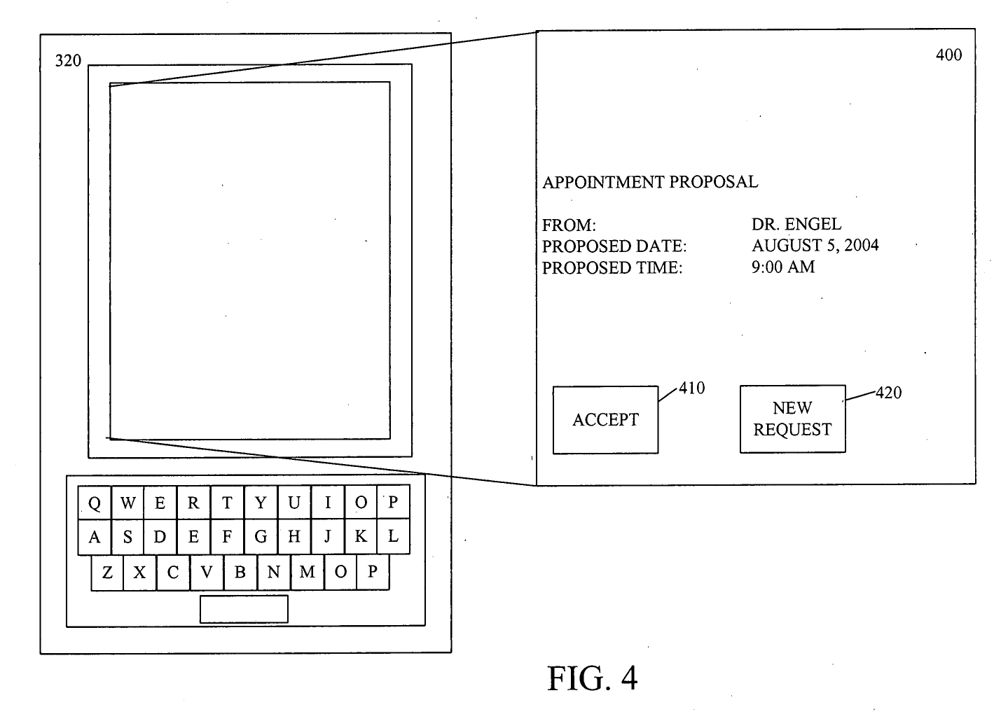

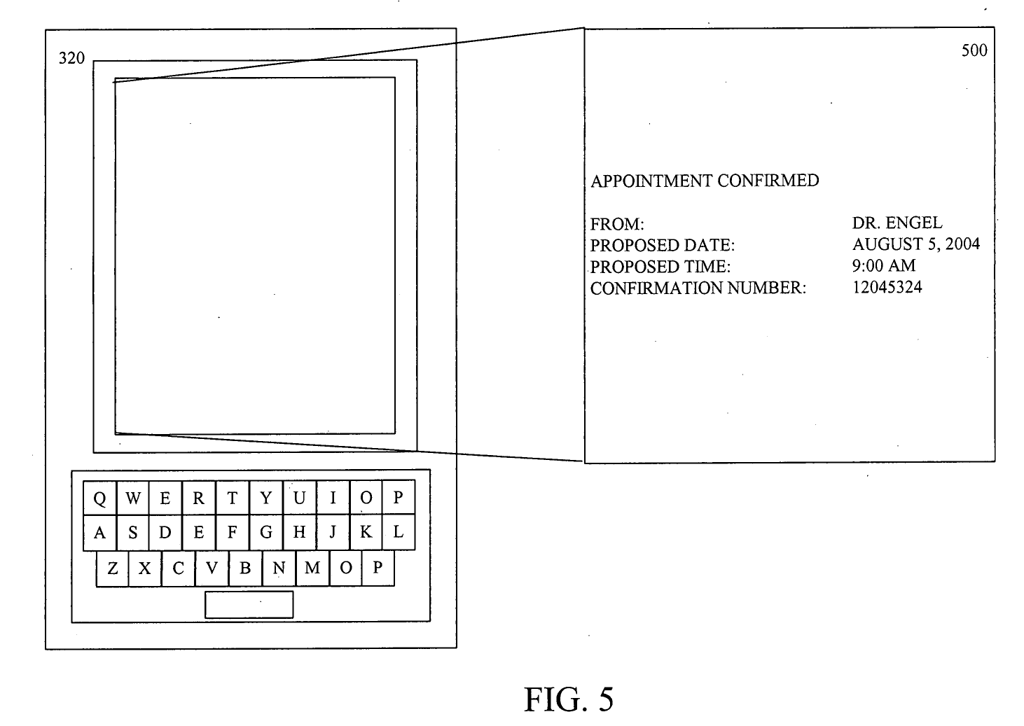

Next, FIG. 4 shows a message 400 containing a suggested appointment time that is sent by the arbitration module 190 to the communication device 320 of the user. As shown, the message 400 in FIG. 4 identifies the subject, the proposed time, and proposed date for setting up an appointment. To accept or reject the suggested appointment date and time, the user can activate the appropriate button 410, 420 on the bottom of the message. If the user accepts the suggested appointment time, the user receives a confirmation message 500 from the arbitration module 190, as shown in FIG. 5. A reminder message may also be sent to the participants before a date of an appointment occurs, in some embodiments.

In other embodiments, an appointment manager 194 may be employed by the first party to make the appointment request. For example, via templates or forms on an appointment manager 194 (such as a web page or software running on a communications device), the appointment manager 194 may assist a party in providing pertinent information for making an appointment request. The appointment manager 194 may be located in a communications device 120 or, as shown in FIG. 1, be implemented separately. For example, the appointment manager 194 may be embodied by web pages that are accessed using the web server 196.

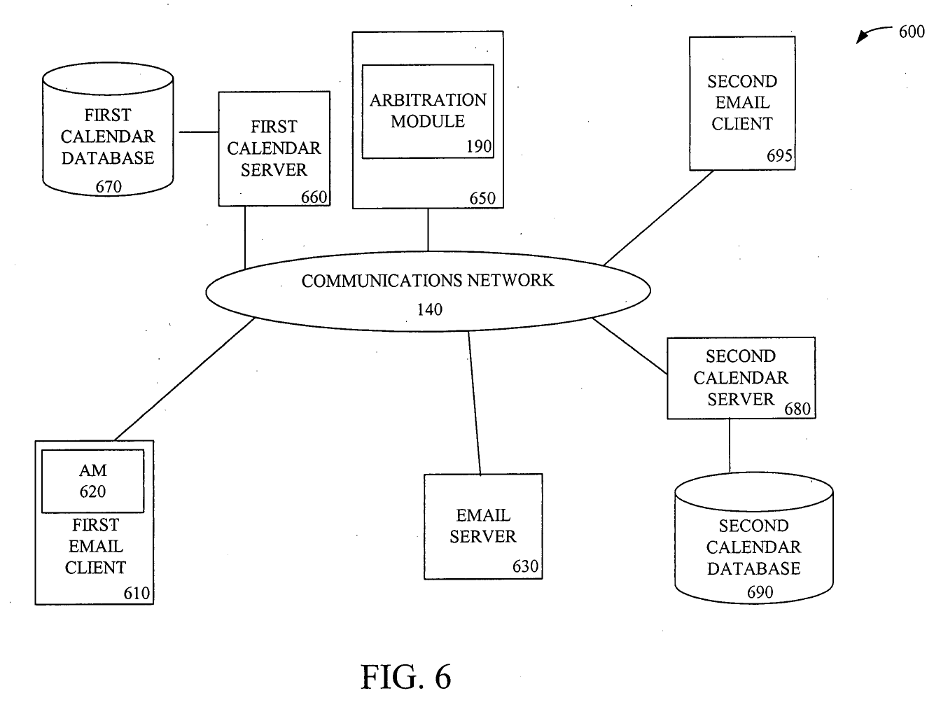

FIG. 6 shows one embodiment 600, among others, of the appointment arbiter system utilizing e-mail communication messages for setting up an appointment. In the embodiment 600 shown in FIG. 6, an e-mail client 610 of a first party (“first e-mail client”) utilizes an appointment manager application (“AM”) 620 to make an appointment e-mail request that is sent (via an e-mail server 630) to an arbitration module 190 at a network server 650 over a communication network 140. The arbitration module 190 retrieves information (via a first calendar server 660) about the first party from an electronic calendar that is stored in a first calendar database 670. The arbitration module 190 uses this information to determine a date and a time for setting up an appointment with another entity. The other entity, such as a second party, may be identified in the appointment request by the first party or may be determined by the arbitration module 190 based on information contained in the appointment request, for some embodiments. In addition, information about a second party may be retrieved (via a second calendar server 680) from an electronic calendar of the second party that is stored in a second calendar database 690. After a subject, an appointment date, and an appointment time is determined, the first party and the second party are notified about the suggested appointment via their respective e-mail clients (e.g., first e-mail client 610, second e-mail client 695).

For some embodiments, to make an appointment request, the appointment manager 194 may provide data fields to provide certain information (e.g., name, address, etc.) and also provide dropdown lists for specifying certain information (e.g., times, dates, nature of appointment, etc.) In some embodiments, the appointment manager 194 may also be activated from a contacts window interface (containing e-mail addresses, instant messaging addresses, phone numbers, etc.) from a computer application.

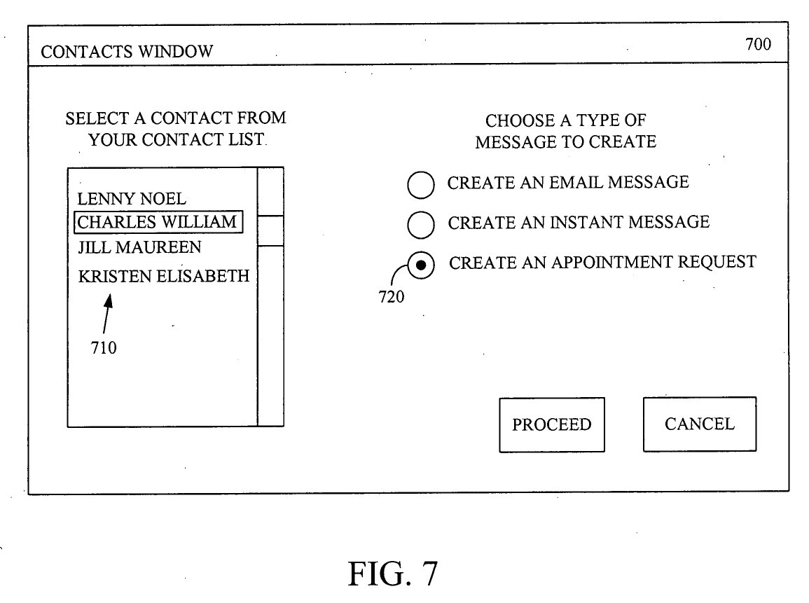

For example, FIG. 7 shows one embodiment of a contacts window interface 700. From the contacts window interface (that may be activated from an interface to a calendaring system or a messaging system), a user has the capability to select a contact 710 and to specify a function to be performed (by clicking on a radio button 720 next to the function), such as sending an e-mail message, making an appointment request, creating an instant message, etc.) If the user selects a contact and specifies that an appointment request is to be made, the selected contact could then be used to retrieve an electronic calendar and/or profile associated with the subject of the selected contact by the arbitration module 190 when the arbitration module 190 receives the appointment request. Therefore, in some embodiments, the arbitration module 190 maintains a database of contacts and an association or mapping between respective contacts and electronic calendars in order to retrieve information from an electronic calendar that is associated with a particular contact.

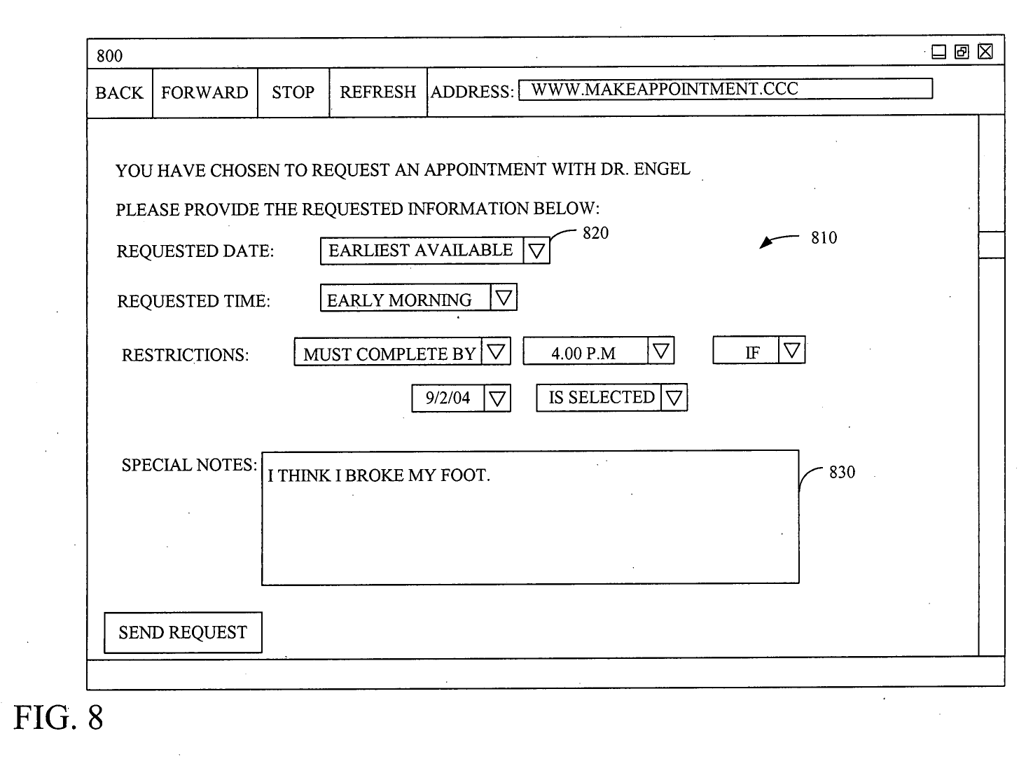

Further, in other embodiments, for example, the first party may access web pages from a web server 196 that enable a party to generate an appointment request. For example, a provider of a referral service may enable a party to go to a web site sponsored by the provider that allows the party to request an appointment with a service provider (e.g., plumber, mechanic, landscape artist, etc.) for a certain time (1:00 P.M., a.s.a.p., this week, etc.) and a certain geographic location (e.g., a certain zip code, area code, home address, etc.). Further, the web site may utilize a template to facilitate selecting the service being requested; the requested appointment time and date; and additional criteria (via dropdown lists), and notes or comments (via a box for typing free form text). An example web page or template 800 for generating an appointment request is shown in FIG. 8.

Within this template 800, a restrictions field or a constraints field 810 may be provided so that criteria may be specified for setting up an appointment. The restriction parameters 810 (e.g. I need the appt to be after 4 p.m.) are part of the appointment request and are associated directly with the appointment request and are not considered global criteria that should be applied generally to other appointment requests made by the first party.

Using the restriction parameters 810, an appointment can be chosen that does not conflict with a party's constraints. Via drop down lists or menus 820, a party may be able to select or construct a variety of restriction parameters that are recognized by the arbitration module 190 and utilized to select an appointment that satisfies the specified restriction parameter. For example, if restriction parameters indicate that Mondays are not an acceptable date for an appointment, then the arbitration module 190 attempts to select a date that is not on a Monday.

In addition, a specific time and/or date, a time interval, etc. may be specified for the appointment request. In accordance with some embodiments, a template presented to a party may be customized for a subject identified by the party. For example, the web page in FIG. 8 may be provided to a user after the user has already identified the subject (Dr. Engel) of the appointment request. If the user had identified a different subject (e.g., John Smith, Esquire), then a different template may be provided to the user. Templates may be further provided by types of subjects. For example, a subject that is identified to be a mechanic may have a general “mechanic” template form and a subject that is identified to be a hair stylist may have a general “hair stylist” template form. Correspondingly, different types of businesses may have different types of criteria. For example, a template for a medical office could have fields to ensure ability to pay for an appointment such as an insurance field or other requirements. Also, as previously suggested, a particular subject may provide a customized template for making an appointment request.

In addition to dropdown lists, a notes field 830 may also be provided in a web page or template 800 for making an appointment request. In this way, a party can provide additional instruction or information to a subject of an appointment request that may be pertinent in providing the requested service. According to an exemplary embodiment, information provided in a notes field 800 may be considered after the appointment is set up and before the appointment occurs.

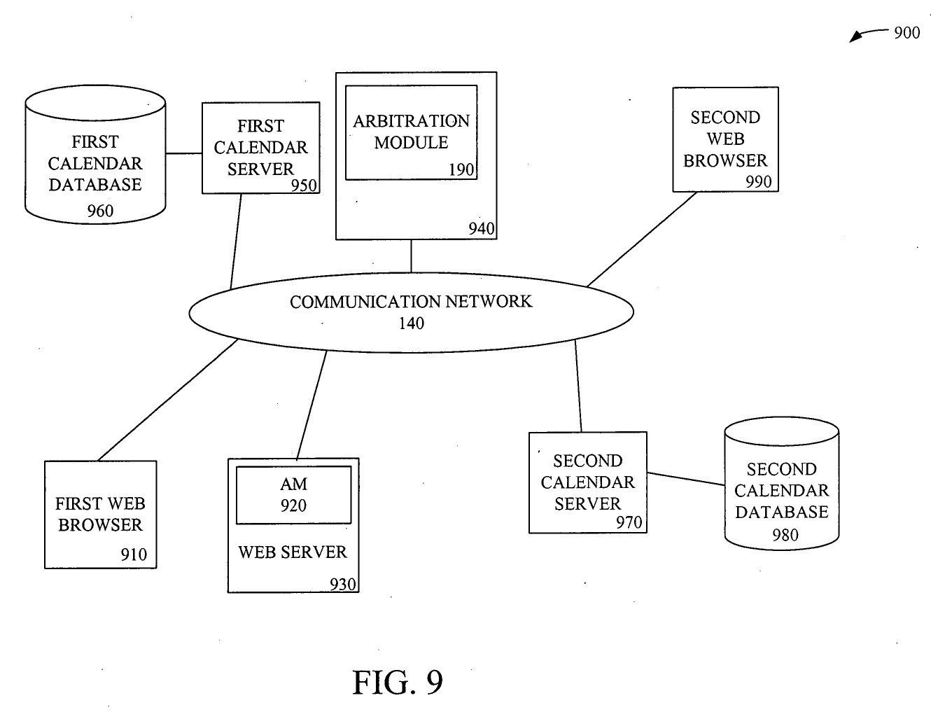

Next, FIG. 9 shows one embodiment 900, among others, of the appointment arbiter system utilizing web-based communication messages for setting up an appointment. In the embodiment shown in FIG. 9, a web browser 910 of a first party (“first web browser”) utilizes an appointment manager application 920 (via a web server 930) to make an appointment request that is sent (via the web server 930) to an arbitration module 190 at a network server 940 over communication network 140. The arbitration module 190 retrieves information (via a first calendar server 950) about the first party from an electronic calendar that is stored in a first calendar database 960. The arbitration module 190 uses this information to determine a date and a time for setting up an appointment with another entity. The other entity, such as a second party, may be identified in the appointment request by the first party or may be determined by the arbitration module 190 based on information contained in the appointment request, for some embodiments. In addition, information about the second party may be retrieved (via a second calendar server 970) from an electronic calendar of the second party that is stored in a second calendar database 980. After a subject, an appointment date, and an appointment time is determined by the arbitration module 190, the first party and the second party are notified about the suggested appointment via their respective web browsers 910, 990 (e.g., by using web-based e-mail, receiving a notification on a web page, etc.)

Referring again to FIG. 1, regardless of the particular form of communications device 120, the appointment request may contain appointment parameters delineating requirements for the appointment. For example, if a first party desires to set up a dental appointment with a particular dentist, the first party can specify the name of a dentist and any other information that the first party deems necessary for making an acceptable appointment, such as a desired date or range of acceptable dates and a particular time or a range of acceptable times. Accordingly, the first party can also describe which times or dates are acceptable by simply picking a time/date or range of times/dates that are not acceptable.

To help in specifying appointment parameters, the communications client 120 may use an appointment template. For example, the specified dentist may have a template that can be used in making appointment requests which makes identifying appointment parameters easy. For example, if a web-based appointment manager 194 is accessed to make an appointment request, a template (in the form of web page(s)) may be provided to the first party after the first party identifies a particular dentist as the subject of an appointment request. Alternatively, if a local appointment manager 194 (stored on a communications device) is used, the appointment manager 194 may retrieve the template of the subject of an appointment from a local or remote database after the subject is identified.

Some appointment parameters that may be used to make an appointment request include a particular recipient of the request, a particular time for the appointment, an acceptable time range for the appointment, an unacceptable time for the appointment, an unacceptable time range for the appointment, etc. Additionally, in some embodiments, a party may also maintain an electronic calendar, and therefore, the electronic calendar of an entity may be utilized to determine acceptable time ranges for an appointment. For example, criteria stated in an electronic calendar of a user may generally apply to any appointment request made by the user and be considered as global criteria. Thus, if an electronic calendar indicates that a user is on vacation for the whole month of February, then the arbitration module 190 may consider that pertinent information to make a suggested appointment time, for some embodiments. However, if the appointment request expressly specifies a particular date and time for an appointment request (e.g., 2 p.m. on May 12), then the arbitration module 190 may recognize, in some embodiments, that the electronic calendar of a party does not need to be checked, since the desired date and time can be determined solely from the appointment request, even though the arbitration module 190 has the capability to check the electronic calendar of the party.

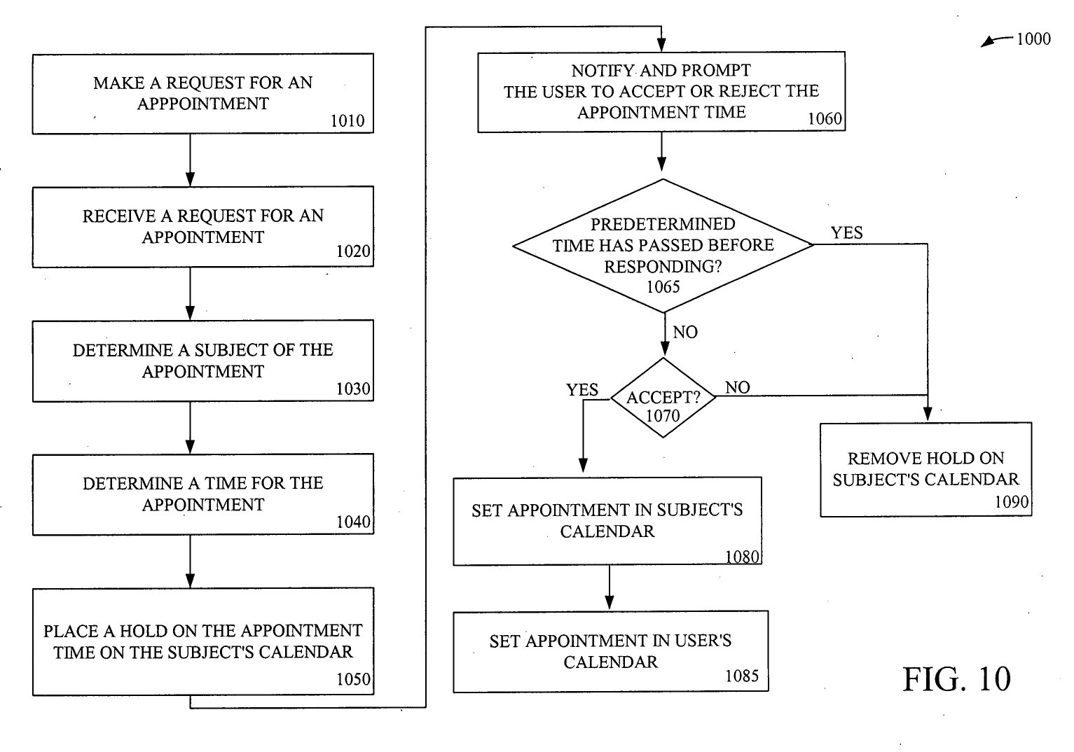

Accordingly, FIG. 10 shows one embodiment 1000, among others, of a process for setting an appointment using the electronic calendars of both the party requesting the appointment and a subject of the appointment. Accordingly, in FIG. 10, the first party makes (1010) a request for an appointment (via a communication device) that is to be set up by the arbitration module 190. Consider, in some embodiments, the first party, such as a user, may be prompted to make an appointment request by another party. For example, a car dealership may send a communication message to the first party to prompt the first party to schedule an appointment (with the dealership) for having an automobile serviced for a scheduled tune-up.

Referring back to FIG. 10, the appointment request is received (1020) by the arbitration module 190. The arbitration module 190 analyzes the request to determine (1030) a subject of the appointment. The identity of the subject may or may not be specified in the appointment request. If the subject is expressly identified, then the arbitration module 190 can quickly determine the subject from the appointment request. Alternatively, if the subject is not expressly identified, then the arbitration module 190 determines a subject that matches criteria specified in the appointment request by comparing appointment criteria with information known about potential subjects.

In addition to determining the appointment subject, the arbitration module 190 also determines (1040) a time for the appointment. To determine a time for the appointment, the arbitration module 190 examines the electronic calendar of the first party along with the electronic calendar of the subject in order to find an available time on each calendar that satisfies and does not conflict with appointment criteria indicated in the appointment request, a party's profile, or contained on a party's calendar. After determining a time for the appointment, the arbitration module 190 places (1050) a hold on the suggested time on the subject's electronic calendar to prevent the subject from scheduling another event (appointment, reminder, etc.) for the suggested time. Then, the arbitration module 190 notifies and prompts (1060) the first party making the request to either accept the suggested appointment time or to reject the suggested appointment time before a predetermined amount of time passes (1065) (e.g., five days). If the user accepts (1070) the suggested appointment time, the appointment is written or set (1080) to the electronic calendar of the subject and also written to the electronic calendar (1085) of the first party by direction of the arbitration module 190. Alternatively, if the user rejects (1070) the suggested appointment time or if a predetermined amount of time passes before the user responds (1065), the hold on the suggested time is removed (1090) from the electronic calendar of the subject by the arbitration module 190.

When the request for setting up an appointment is sent from the communications device 120 to the arbitration module 190, the arbitration module 190 parses the request to procure appointment parameters contained in the request itself that can be used to set up an appointment. Further, the arbitration module 190 retrieves other information that is pertinent to setting up the appointment. As previously stated, the arbitration module 190 may access an electronic calendar or schedule of the requestor of the appointment to check the availability of the requestor on different dates and times. In some embodiments, an e-mail address of an identified subject that is contained in an appointment request may be used to retrieve an electronic calendar associated with the e-mail address. Alternatively, the arbitration module 190 may not be provided with a party's electronic calendar. Rather, the arbitration module 190 may be provided with information that has been extracted from the calendar and provided to the arbitration module 190, such as information delineating the available dates and times contained in the calendar.

According to an exemplary embodiment, to access an electric calendar of a party, the arbitration module 190 has to receive authorization from the party before access is provided. Authorization may be provided in several ways. For example, if the arbitration module 190 is co-located on a communications device 120 with the electronic calendar, then the arbitration module 190 is assumed to be authorized to access the electronic calendar, in some embodiments. However, in other situations, the arbitration module 190 may be provided a username and/or password associated with the requestor that can be used to access the requestor's availability information. Correspondingly, if a requestor identifies the subject of an appointment or a potential subject is identified by the arbitration module 190, the electronic calendar and/or availability information of the subject may be accessed after proper authorization is shown by the arbitration module 190.

For example, in some embodiments, an arbitration module 190 may prompt a requestor to provide a password for accessing an electronic calendar of a subject, where the subject provided the password to the requester. Then, the arbitration module 190 presents the password to a calendar server associated with the electronic calendar of the subject to show that the arbitration module 190 is authorized to access the electronic calendar of the subject. In other embodiments, the subject may maintain a list of entities that are authorized to access its electronic calendar. Therefore, an arbitration module 190 may present the name of a requestor to a respective calendar server, and if the name of the requestor is on the list, then the arbitration module is allowed to access information from the electronic calendar of the subject on behalf of the requester.

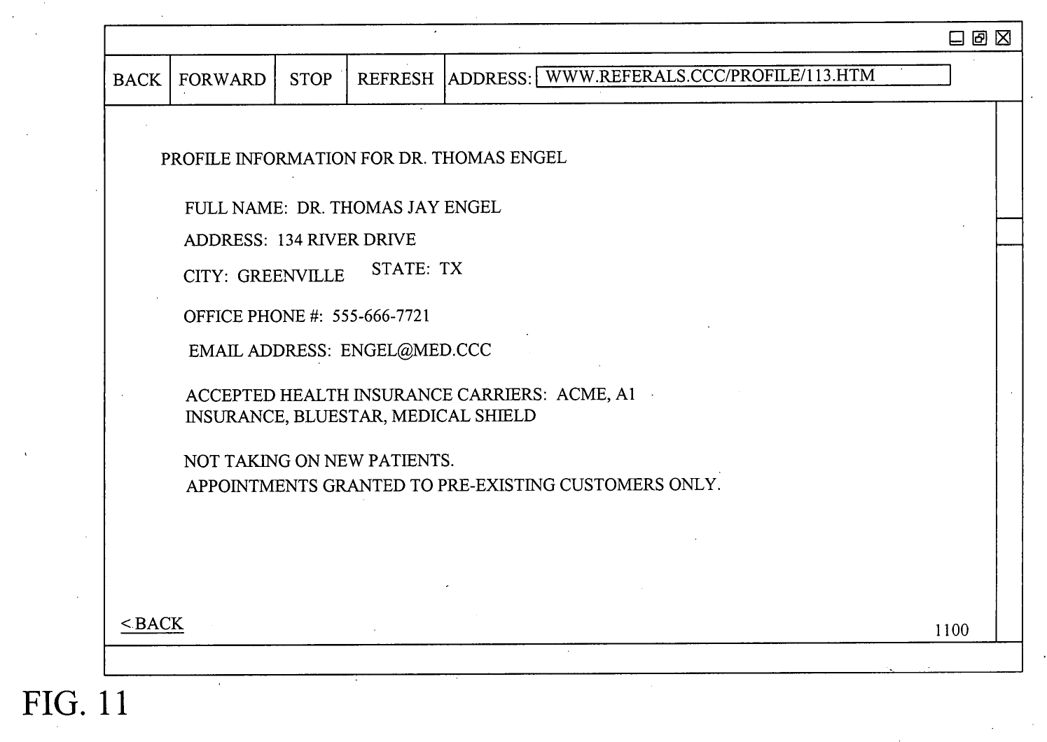

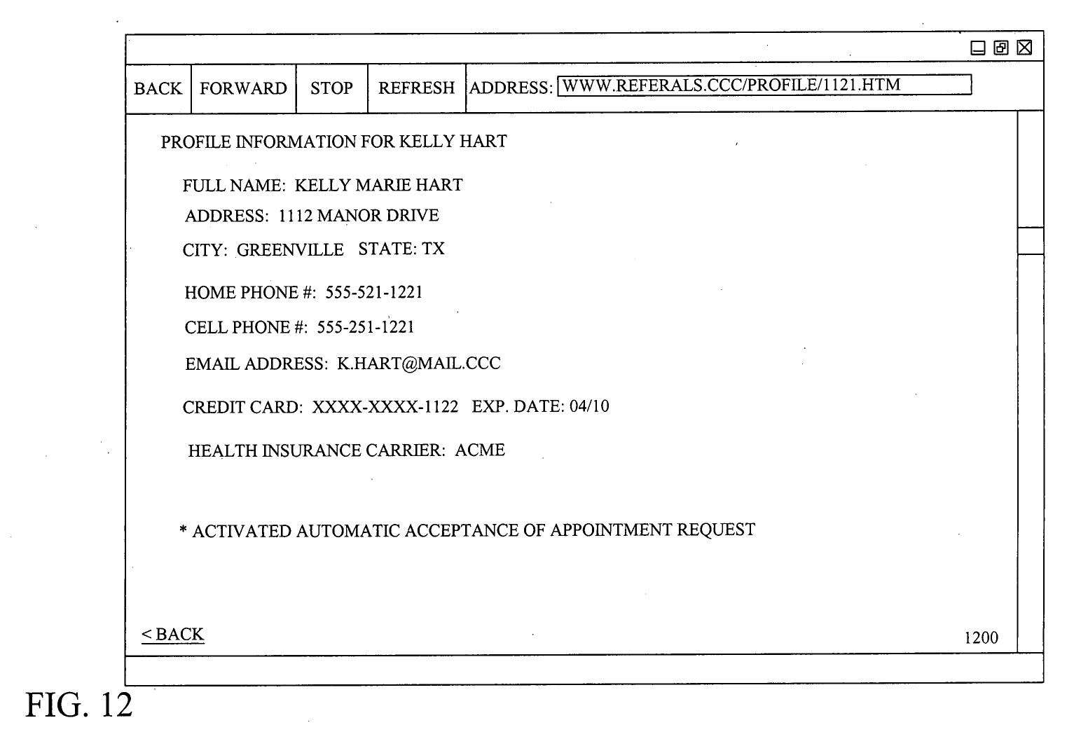

In addition to electronic calendar information, profile information of the involved parties may also be examined by the arbitration module 190 and be used by the arbitration module 190 to select an appointment time. Therefore, the arbitration module 190 attempts to take into account multiple sets of information that is known about the requestor (e.g., information provided in the appointment request, electronic calendar information, profile information, etc.) and an (expressly identified or potential) subject to determine a proposed appointment. For example, in some embodiments, a requestor specifies requirements and/or preferences for a service provider (who is to perform a requested service) that is to be the subject of an appointment request without specifically identifying a particular service provider. Therefore, for service providers who are to be considered as potential subjects of appointment requests, the profiles of the service providers, in some embodiments, contain criteria specifying the parameters that they are willing to accept in an appointment request, such as the services they perform, the geographic location they serve, the minimum fees for their services, etc. Accordingly, FIGS. 11-12 show embodiments among others, of a profile 1100 of a particular service provider and a profile 1200 of a requesting user being displayed in a web browser. Each profile contains criteria that should be considered in setting up an appointment involving either party. In addition, the respective parties also may maintain electronic calendars that show additional constraints and other criteria that should be considered, such as their current availability times.

Therefore, in some embodiments, the arbitration module 190 can examine the profiles of a subject, such as potential service providers, in determining an appropriate match with appointment criteria of a party that has sent an appointment request. In addition, the arbitration module 190 can also examine additional sources of information to set up an appointment. For example, for service providers, a requester may request a particular service provider that has a high quality rating. Therefore, the arbitration module 190 may access quality ratings that are provided by an outside source or by the provider of a referral service in order to obtain a quality rating of particular service providers.

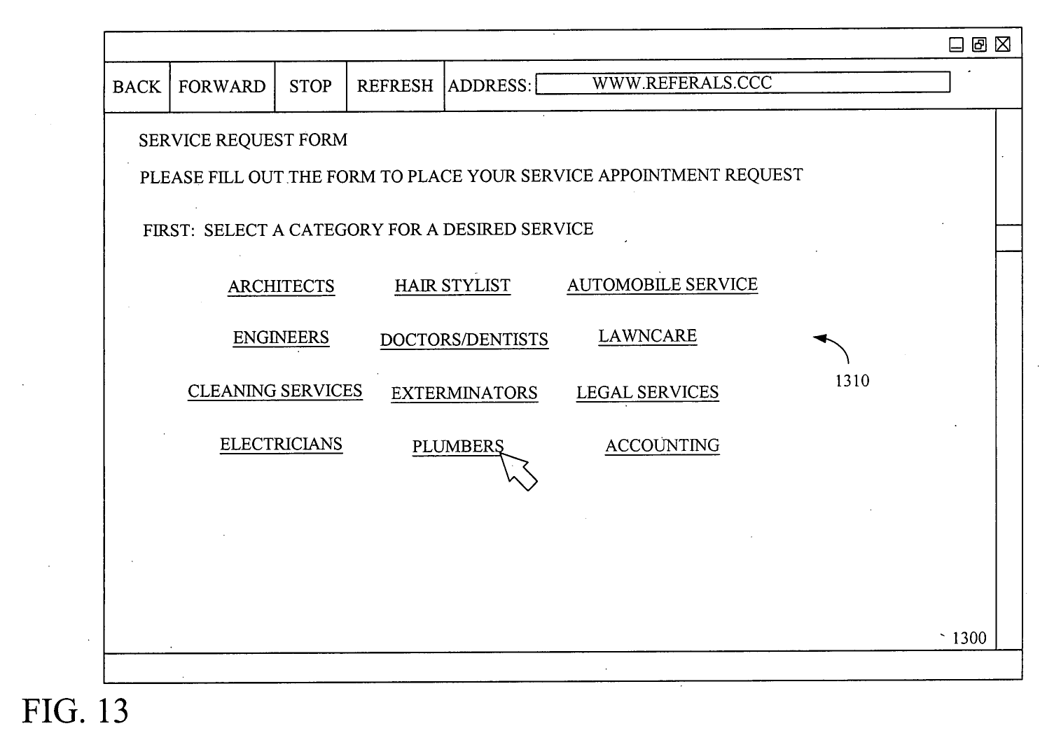

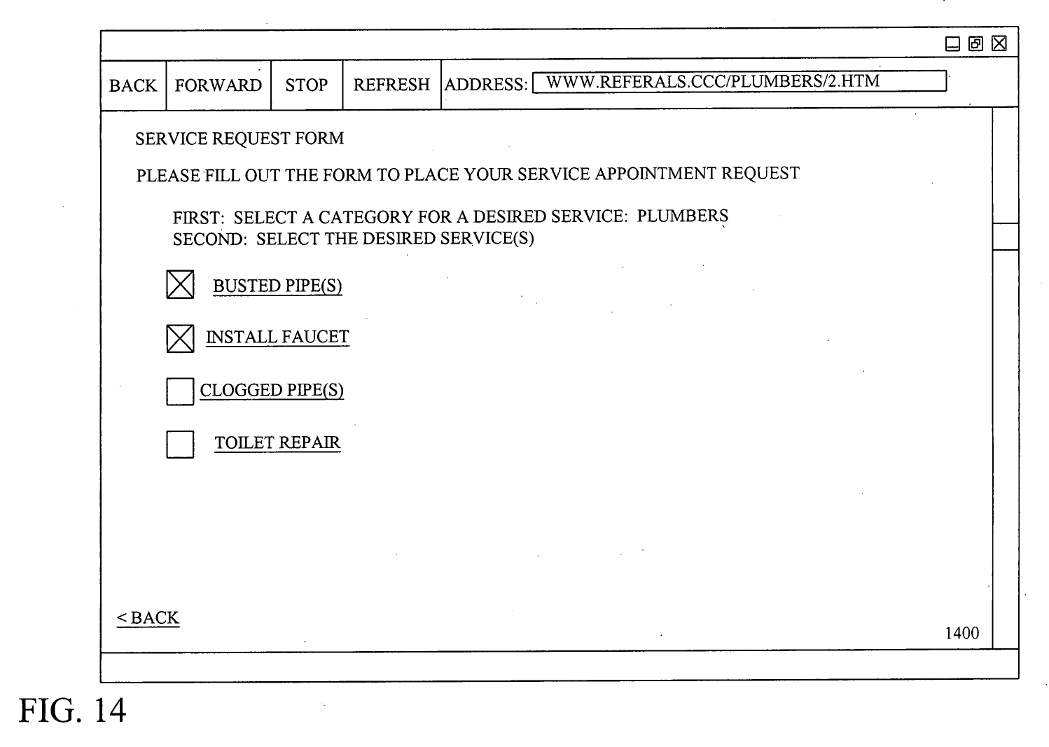

To demonstrate, FIG. 13 shows one embodiment 1300, among others, of a web page facilitating the generation of an appointment request to a referral service. As shown in FIG. 13, a user can select (via a click of a mouse control, for example) a category of service 1310 (e.g., plumbers, doctors, exterminators, etc.) that the user is interested in scheduling an appointment. In the example shown, the user has selected the “plumbers” category. After selecting the “plumbers” category, the user is provided another web page 1400, as shown in FIG. 14. Here, a user is able to select the services that the user wants performed during the requested service appointment. In the example shown, the user has specified that he or she wants to have services performed for busted pipe(s) and installation of a faucet.

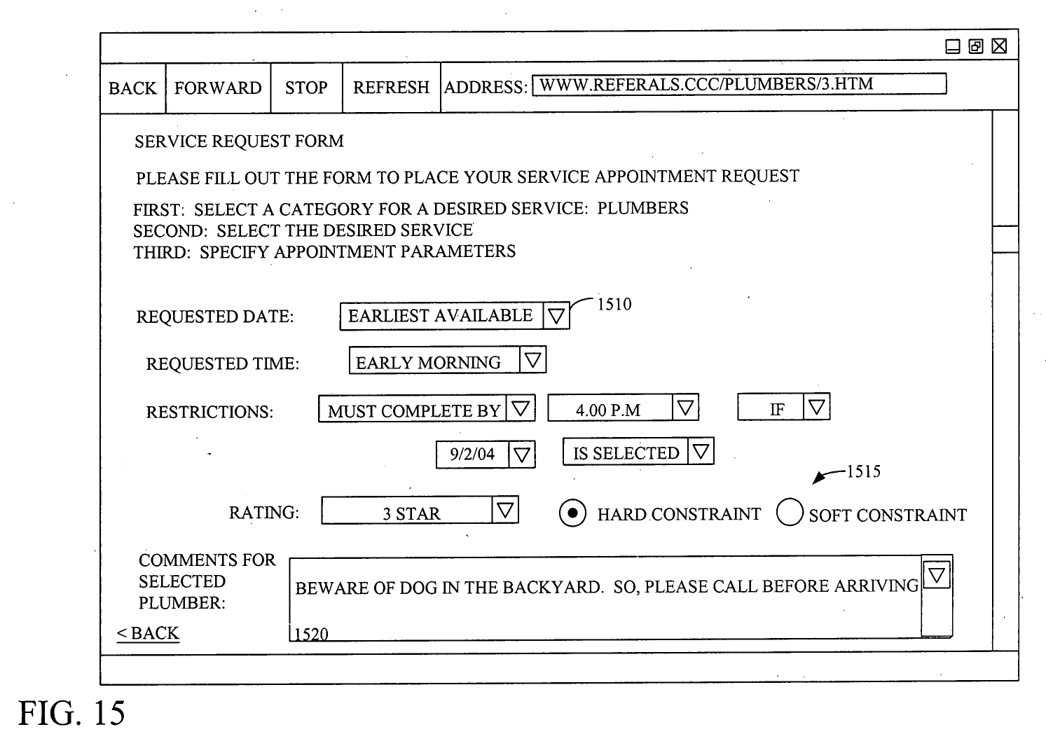

In addition, the user may be prompted to specify additional information, as shown in FIG. 15. Here, the user is prompted to choose a time and a date for the appointment. As shown, selection of the date and time may be facilitated by use of drop down menus 1510. In the example shown, the user has requested an appointment time for the “earliest available” date in the “early morning” time period. Further, the user can specify additional requirements such as a requirement that the appointment has to be completed by a certain time if a certain date is selected. A wide variety of restrictions and preferences may be made in an appointment request for different embodiments and are contemplated by the present disclosure. For example, in the example of FIG. 15, the user also specified a requirement for the service provider to have at a minimum a certain quality grade or rating of 3 stars. For some embodiments, the user may also be able to classify a requirement (via radio buttons 1515) as being a hard constraint that has to be satisfied to set an appointment or a soft constraint that would be preferred to be satisfied but is not required to be satisfied in setting up an appointment. In addition, the user can be provided a box 1520 for providing instructions or additional comments to be considered by a service provider, as shown.

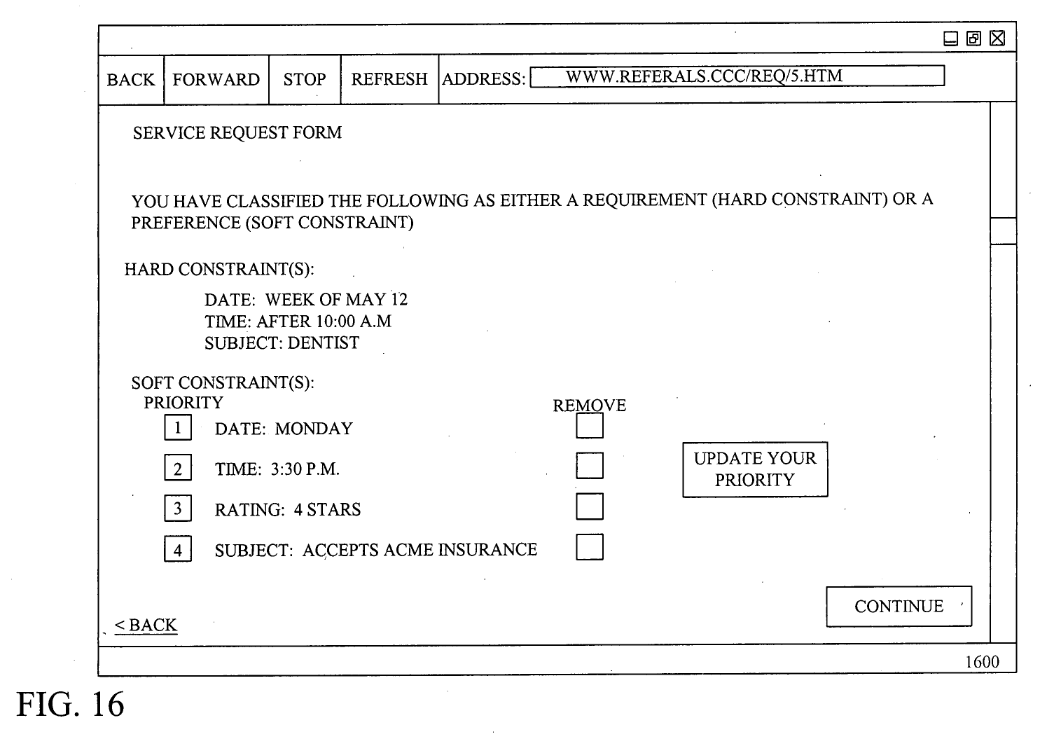

To determine an appointment, the arbitration module 190 may also consider a ranking of criteria provided by the requester. For example, in making a request, the requestor may classify which criterion is more important than others. Therefore, if the requestor chooses that a desired time of the appointment is more important than a quality rating possessed by a service provider, the arbitration module 190 will first consider service providers who are able to meet the desired appointment time. In contrast, if the requestor chooses that a quality rating is more important than an exact appointment time, the arbitration module will first select the service providers of a desired quality rating and then attempt to select a particular service provider who matches the desired time provided by the requester. To demonstrate, FIG. 16 shows one embodiment, among others, of a web-based interface 1600 for ranking appointment criteria.

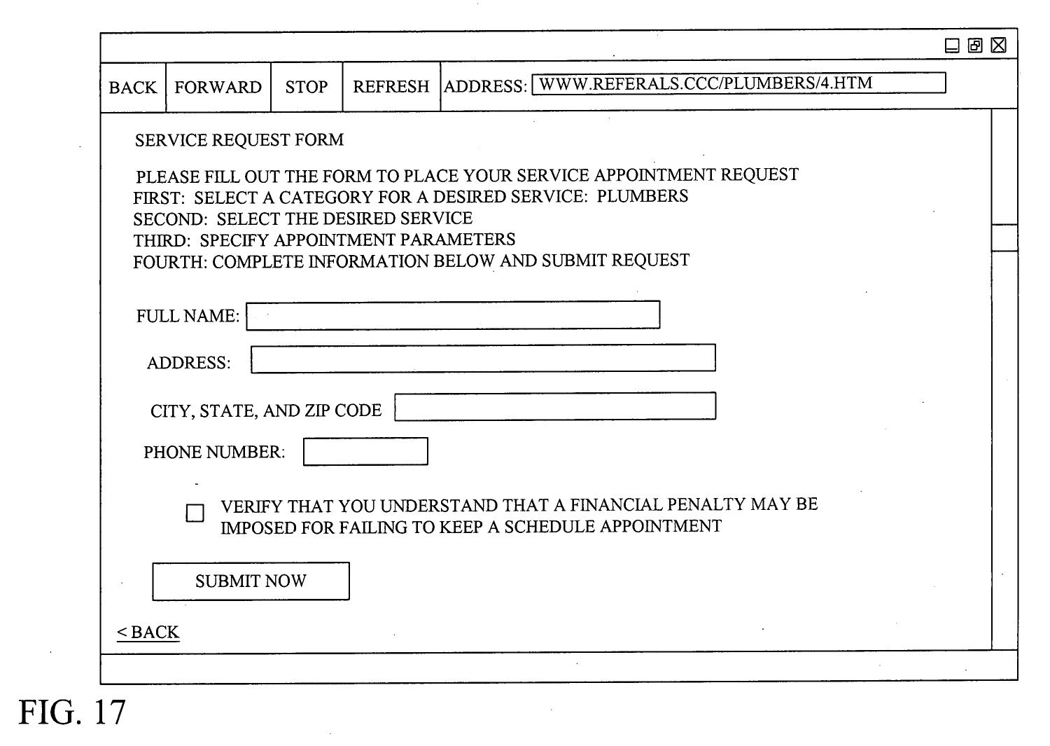

Note, in some embodiments, information that may be contained in a profile is provided when an appointment request is made, as shown in FIG. 17. Here, for example, a user is prompted to provide his or her name, address, and telephone information. Other information could also be requested, in some embodiments. As shown, some embodiments of the present disclosure provide a process for setting up an appointment where a requestor describes parameters or criteria for scheduling the appointment. This also extends to the situation where a requestor sends an appointment request to a referral system and queries the referral system to not only set up an appointment time but to also refer the requestor to a party that can accommodate the needs of the appointment. Further, a subject of the appointment (whether identified in the request or selected by a referral service) allows an arbitration module 190 to automate setting up the appointment on its behalf. Therefore, the arbitration module 190 selects an appointment time that is unilaterally approved by the requestor to provide a fast and efficient manner of setting up an appointment.

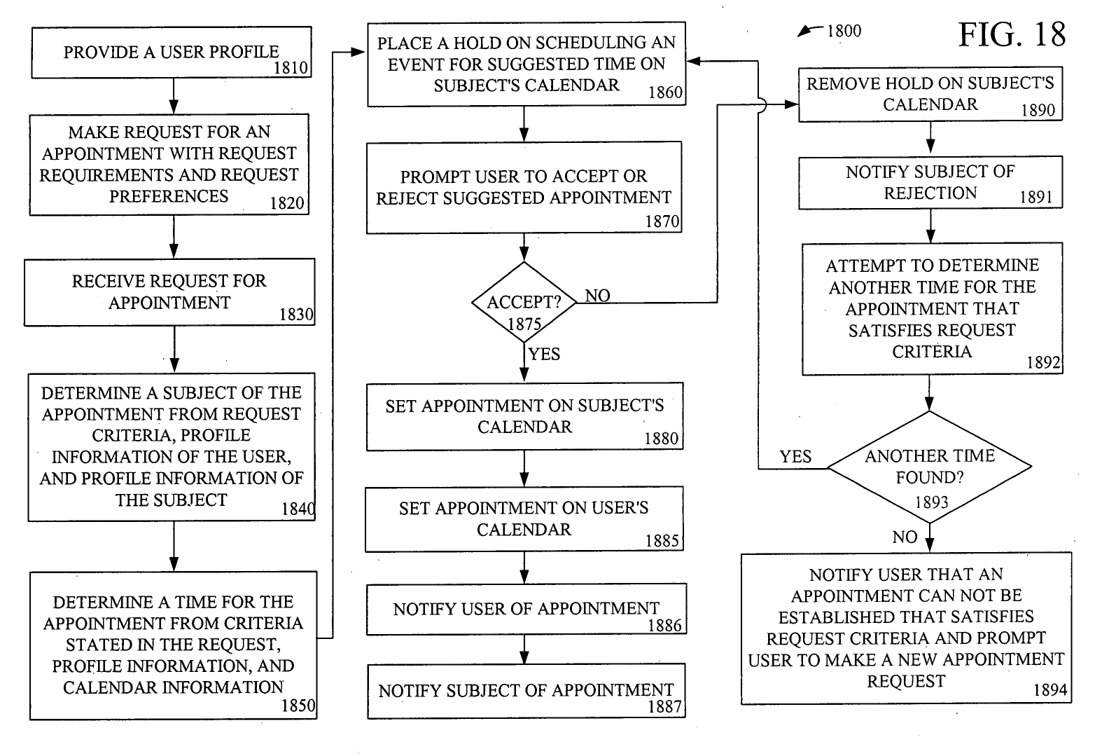

The flowchart of FIG. 18 shows one embodiment 1800, among others, of a process for setting up an appointment by examining different sets of information that are pertinent to setting up the appointment. For example, in FIG. 18, a user profile is provided (1810) with global appointment criteria. Next, the user makes (1820) a request for an appointment where the request contains requirements (“hard constraints”) for an appointment and preferences (“soft constraints”) for the appointment. For example, the user may specify a requirement that an appointment has to be scheduled for a Friday and a preference that the appointment be scheduled after 3 P.M. The request is then sent to and received (1830) by the arbitration module 190. The arbitration module then determines (1840) a subject of the appointment by examining a) the appointment criteria (e.g., requirements, preferences, etc.) provided in the request; b) information contained in the profile of the user making the request (e.g., the user lives in Atlanta, Ga.); and the profile information of a potential subject (e.g., the potential subject lives in Atlanta, Ga.) to determine if a potential subject matches the criteria of the user, as stated in the appointment request and as contained in the user's profile.

For a situation where more than one service provider satisfies the criteria of a requester, a tiebreak process may be imposed to select between more than one service providers. A variety of tiebreak processes may be used in different embodiments. For example, one tiebreak process involves a random selection amongst the service providers that are being considered. Another tiebreak process that may also be used, in some embodiments, is to select the service provider who has not recently been selected in comparison to the other service providers being considered. Another tiebreak process may determine which subject is more willing to pay or bid the highest price for receiving the appointment. Alternatively, the service provider could win a bid for an appointment by offering the lowest discount to the requestor for the service to be performed. Alternatively, the referral service could select the service provider who is currently paying a highest fee for being a member of the referral service. Therefore, in addition to criteria specified by a requestor and criteria specified by a subject, the arbitration module 190, in some embodiments, also selects an appointment based on criteria specified by a provider of the referral service, such as information delineating which service provider has paid a premium advertising fee to the referral service.

Next, the arbitration module 190 determines (1850) a time for the appointment that satisfies criteria obtained from the appointment request, criteria obtained from profile information of the user making the request and a subject; and criteria obtained from the calendars of the requestor and subject. Further, the time is also selected, if possible, that best satisfies preferences stated in the appointment request and the profiles of the requestor and subject (e.g., geographic location considerations, etc.). After a time is determined, the arbitration module 190 accesses the electronic calendar of the subject and places (1860) a hold on scheduling any other events for the suggested time. Further, the arbitration module 190 notifies the user of the details of the suggested appointment selected by the arbitration module 190 and prompts (1870) the user to accept/approve or reject the suggested appointment. The chosen subject is notified of the details of the suggested appointment, in some embodiments.

If the user accepts (1875) the suggested appointment, the arbitration module 190 writes or sets (1880) the appointment on the subject's calendar (or directs a calendar server to record the appointment on the subject's calendar). Further, the arbitration module writes or sets (1885) the appointment on the user's calendar (or directs a calendar server to record the appointment on the user's calendar). The user is also notified (1886) of the appointment via a communication message that is sent to the user. In a similar manner, the subject is notified (1887) of the establishment of the appointment.

Alternatively, if the user rejects (1875) the suggested appointment, the arbitration module 190 removes (1890) the hold on the subject's calendar for the suggested appointment time and notifies (1891) the subject of the rejection of the suggested appointment. The arbitration module 190 then attempts to determine (1892) another time for the appointment that satisfies the appointment criteria. If another time is found (1893) that satisfies the appointment criteria, then the process partly repeats itself beginning with placing (1860) a hold on the subject's calendar for the new suggested appointment time. If the arbitration module 190 is unable to determine (1893) another time that satisfies the appointment criteria, the user is then notified about the inability of setting up an appointment that satisfies the appointment criteria, and the user is prompted (1894) to make a new appointment request with different appointment criteria. In some embodiments, the arbitration module 190 may provide the requestor a limited number of attempts for the requestor to request the arbitration module 190 to set up another appointment time.

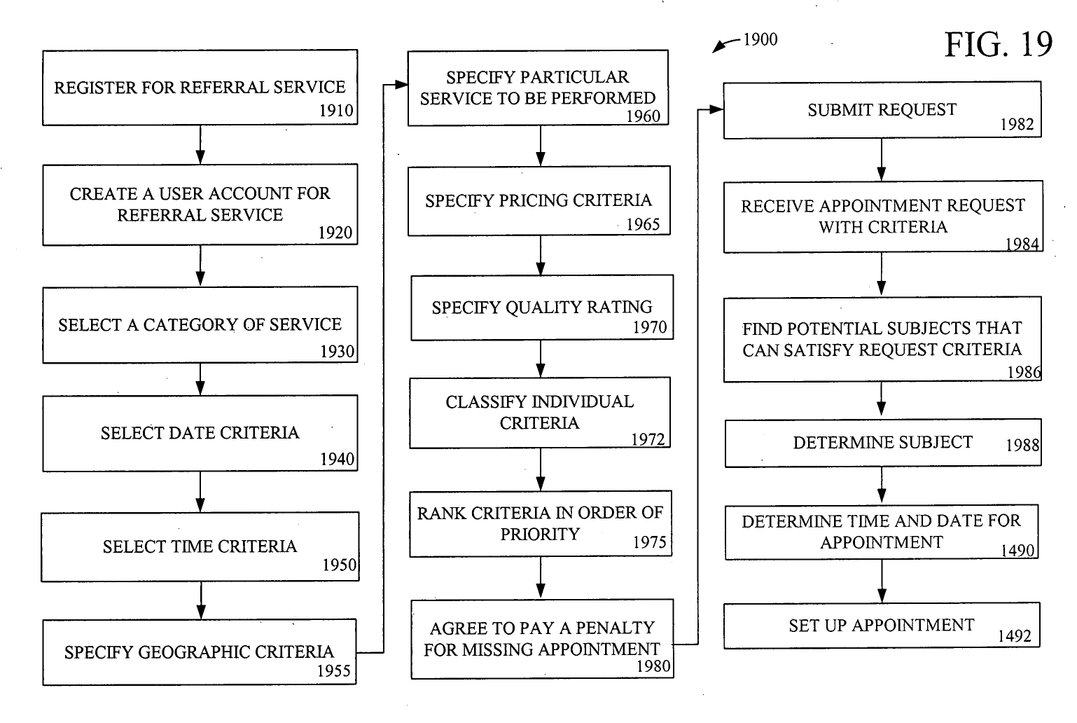

In accordance with some embodiments of the present disclosure, a financial penalty may be imposed on a requestor who fails to honor or show up for a scheduled appointment. To illustrate, the flowchart of FIG. 19 shows one embodiment 1900, among others, of a process for setting up an appointment that imposes a penalty for missing the appointment. In an initial step, a first party, such as a user, registers (1910) for a referral service provided by a referral provider. As part of the registration process, a user account is created (1920) for the user of the referral service. Via the user account, a user can be billed for services or fees associated with the referral service. For example, a credit card number of the user may be associated with the account and be used for billing fees to the user.

According to an exemplary embodiment, using a web site provided by the referral service, the first party requests an appointment and provides appointment criteria. In this particular example, to make the request, the first party selects (1930) a category of service that the first party wants the subject of the appointment to provide, such as “plumbers.” Also, the first party selects (1940) criteria or parameters for the date of the appointment. In addition, the first party selects (1950) criteria or parameters for choosing an acceptable time for the appointment. Other appointment criteria are also specified in this example.

For example, the user selects (1955) geographic criteria (e.g., specifies location where requested service is to be performed); specifies (1960) particular service to be performed (e.g., repair of busted pipe); specifies (1965) pricing criteria (e.g., willing to pay $50/hour); and specify (1970) a quality rating for service provider (e.g., service is rated at a 4 star quality). Further, in some embodiments, the first party can classify (1972) the specified criteria as being a hard constraint that must be satisfied or a soft constraint that should be attempted to be satisfied (but is not an absolute requirement). Further, of the soft constraints, the first party can further rank (1980) the criteria in order of priority so that the criteria that is ranked at a higher priority is attempted to be satisfied over another criteria that is ranked at a lower priority. Accordingly, the referral service shall attempt to closely match the criteria that have been given higher priority by the first party with potential service providers.

In accordance with this particular embodiment, a financial penalty may be assessed against the first party for not showing up to appointments that are set up on behalf of the first party. The financial penalty is assessed by charging a monetary value against the credit card of the first party, in this example. In this way, the scheduling process of FIG. 3 is also being used to form a financial contract between the first party and the referral service. Therefore, as an initial step, the first party is prompted to agree (1980) to pay a financial penalty for missing an appointment that has been set up for the first party with a service provider.

After a request is submitted (1982) by the first party, the arbitration module receives (1984) the appointment request with the appointment criteria for setting up an appointment. The arbitration module 190 uses the appointment criteria to find (1986) potential subjects that satisfy the appointment criteria. For example, if the appointment criteria specifies that the subject needs to be a plumber, then potential subjects are located that are plumbers. If more than one subject is found that satisfies the appointment criteria to the same degree, then a tiebreaker process may be employed to select a subject. After the subject is determined (1988), an appointment date and time are also determined (1990) based on the appointment criteria, and the appointment is then set up (1992) by the referral service.

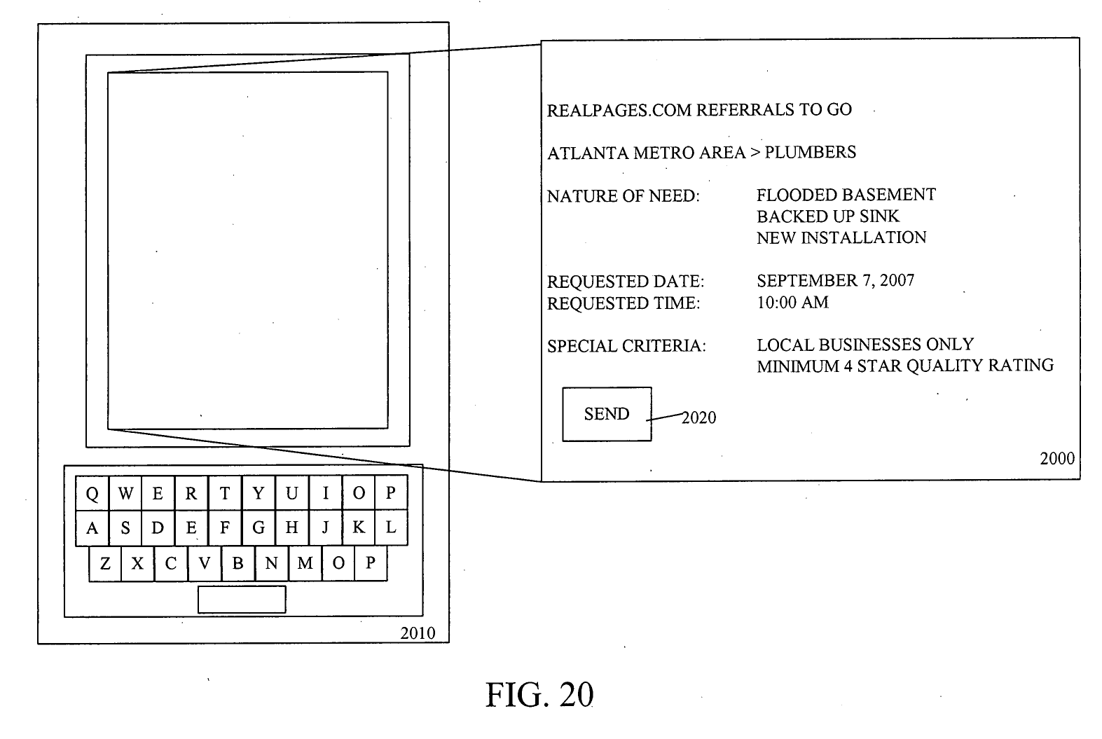

In addition to generating a request for an appointment using a web site provided by a provider of a referral service, some embodiments of the present disclosure utilize different messaging mechanisms for sending an appointment request. For example, FIG. 20 shows one embodiment, among others, of an appointment request 2000 that may be composed using a personal communication device 2010, such as a personal digital assistant. Here, a user has specified that a plumber is needed for the Atlanta metro area to perform services related to a flooded basement, a backed up sink, and performing a new installation. The requested date for the appointment is Sep. 7, 2007 and the requested time is 10:00 A.M. In addition, the user has requested that local businesses be chosen who have a minimum of a 4 star quality or customer rating. In this embodiment, the request 2000 may be sent to the arbitration module 190 by activating a send button 2020.

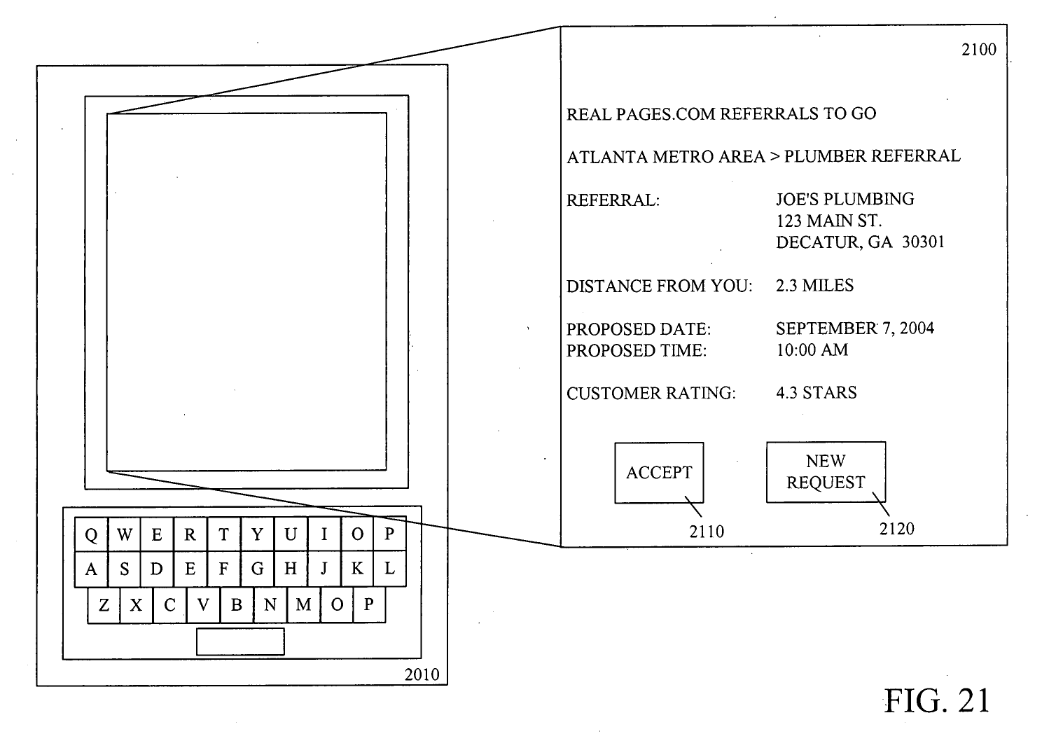

Correspondingly, FIG. 21 shows one embodiment, among others, of a notification message 2100 that is received by a user of a suggested appointment. The notification message 2100 identifies the subject of the appointment (“Joe's Plumbing”), the date and time of the appointment (“Sep. 7, 2007” at “10:00 A.M”), and other related information (address of service provider, customer rating, etc.). For this embodiment, to accept or reject the suggested appointment, the user can select an appropriate button or link 2110, 2120 provided at the bottom of the message (via a user interface of the personal communication device 2010). For example, to accept the appointment, the user can select a send button 2110 and to reject the appointment and request a new appointment, the user can select the new request button 2120. Other embodiments may employ different manners and communication formats for notifying party of suggested appointments, such as a notification shown on an electronic calendar of a party.

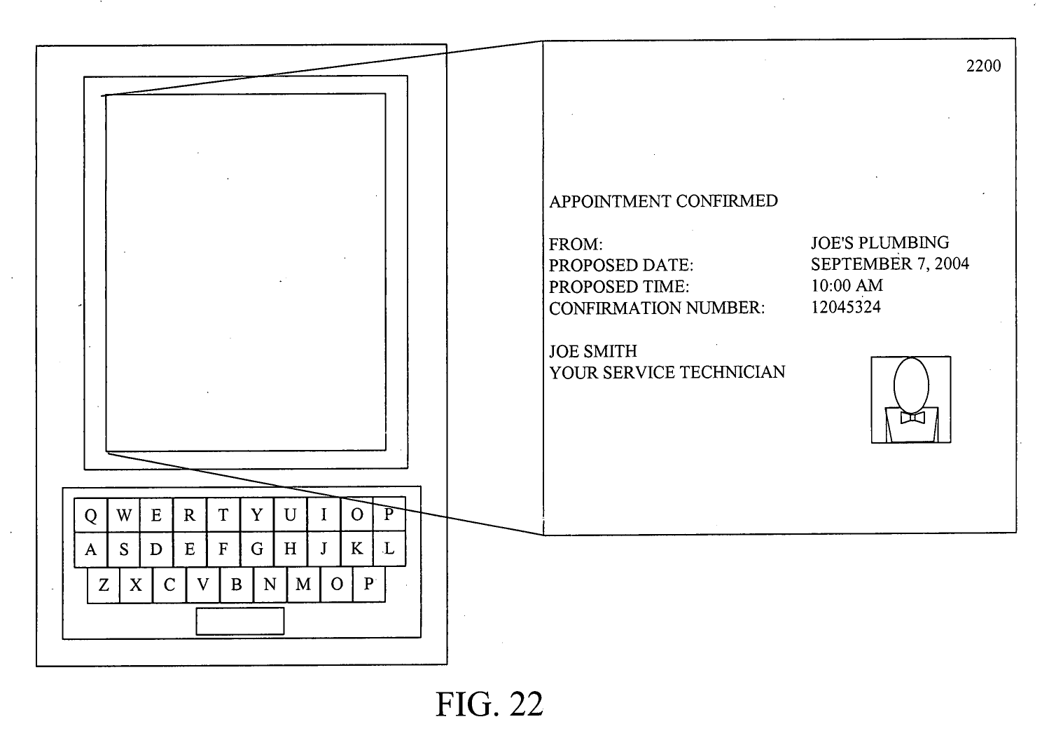

After the user has accepted an appointment, the user receives a confirmation message 2200, as shown in FIG. 22, for some embodiments. The confirmation message 2200 provides the details of the appointment and may also provide additional information such as a confirmation number for tracking the appointment and additional information about the service provider such as the identification of the particular person (e.g., technician) who has been assigned to handle the requested service. For example, confirmation messages can include attachments to calendar entries and include photos, company logos, hyperlinks to web pages providing maps, etc. The confirmation number, in some embodiments, is written to the electronic calendar of respective parties along with other appointment information, such as special notes that were provided in the appointment request.

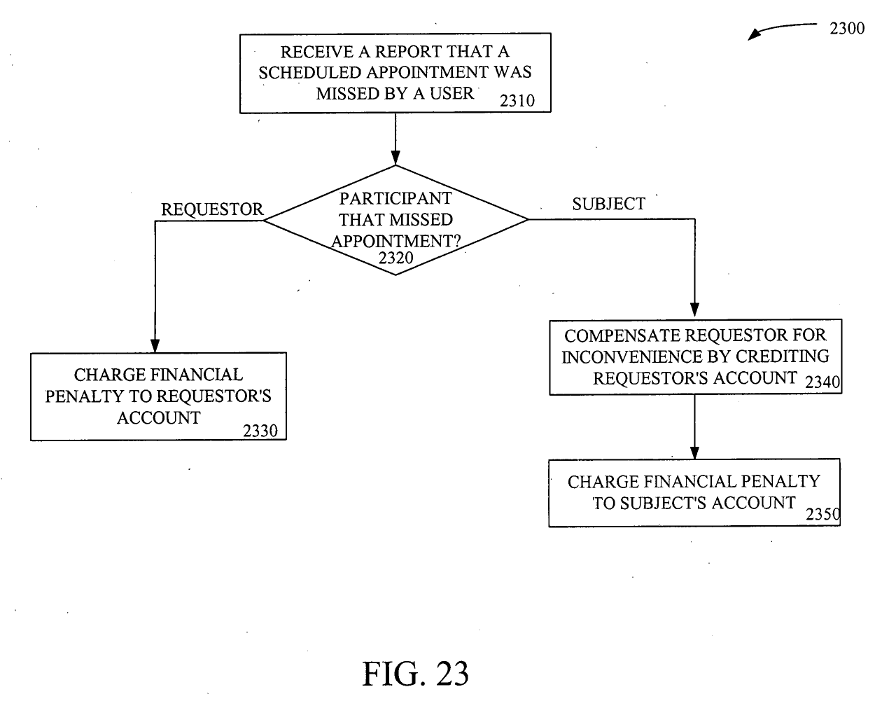

As previously addressed, some embodiments of the present disclosure impose financial penalty upon a user who misses a scheduled appointment. Accordingly, FIG. 23 shows one embodiment 2300, among others, of a process for imposing a financial penalty for missing a scheduled appointment. For example, if an appointment is scheduled by an appointment service between a requesting user and a subject and either of the participants misses or does not honor the scheduled appointment, then the other participant can report the missed appointment to an appointment service (via an e-mail message, filling a form on a web site, talking to an operator, leaving a message on voice mail, utilizing an interactive voice response unit, etc.).

After the report of a missed appointment is received (2310) by the appointment service, the appointment service ascertains (2320) (from the report) whether the user that requested the appointment to be set up or the subject who was specified or chosen for the appointment was the participant who missed the appointment. For the situation where the user that requested the appointment was the participant that missed the appointment, the appointment service charges (2330) or assesses a financial penalty to the user's account with the appointment service. For the situation where the subject of an appointment was the participant who missed the scheduled appointment, the appointment service may compensate (2340) the user who requested the appointment by awarding the account of the user with a financial bonus or credit. Correspondingly, the appointment service may also charge 50) the subject that missed the appointment with the cost of the financial bonus.

In a similar manner, to cancel a scheduled appointment, a user may notify the appointment service of a need to cancel a scheduled appointment. The appointment service may then notify the other party with whom the appointment involves. In addition, the appointment service may impose a financial penalty against the user who canceled the scheduled appointment. In some embodiments, for an emergency situation, the appointment service is notified of the need for an emergency appointment, and then the appointment service rearranges a subject's schedule so that the emergency appointment can be accommodated.

It should be emphasized that the above-described embodiments of the present disclosure are merely possible examples of implementations, merely set forth for a clear understanding of the principles of the disclosures. Many variations and modifications may be made to the above-described embodiments without departing substantially from the spirit and principles of the disclosure. For example, for some embodiments, appointments are scheduled by first having a requestor provide a selected range of appointment parameters (e.g., time/date/price/etc.) and then bounding the requestor to accept the appointment if a subject (e.g., a service provider) agrees to perform a service specified in the appointment request within the specified range.

Further, for some embodiments, a requestor may be notified that an identified subject is not available at a requested appointment time or date. Accordingly, the requestor may be prompted to be added to a waitlist for the subject, such that a hold is placed on the calendar of the requestor at the requested date and time. Therefore, if the subject becomes available for the requested date and time before a predetermined amount of time has passed, then the appointment is scheduled between the requestor and the subject. Alternatively, if the subject does not become available after a predetermined amount of time, then the requestor is removed from the waitlist and the hold on the requestor's calendar is removed.

Certain embodiments of the present disclosure can be implemented in hardware, software, firmware, or a combination thereof. In some embodiments, for example, the arbitration module 190 is implemented in software or firmware that is stored in a memory and that is executed by a suitable instruction execution system. If implemented in hardware, as in an alternative embodiment, the arbitration module 190 can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing steps in a process or as modules, segments, or portions of code which include one or more executable instructions for implementing specific logical functions, and alternate implementations are included within the scope of selected embodiments of the present disclosure in which functions may be executed out of order from that shown or discussed, including substantially concurrently or in reverse order, depending on the functionality involved, as would be understood by those reasonably skilled in the art of the present disclosure.

The arbitration module 190 and other components of the appointment arbiter system 100, in some embodiments, comprise an ordered listing of executable instructions for implementing logical functions, which can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. In addition, the scope of the certain embodiments of the present disclosure includes embodying the functionality of the preferred embodiments of the present disclosure in logic embodied in hardware or software-configured mediums.

As previously mentioned, many variations and modifications may be made to the above-described embodiments of the disclosure without departing substantially from the spirit and principles of the disclosure. All such modifications and variations are intended to be included herein within the scope of this disclosure and protected by the following claims.

Therefore, having thus described the invention, at least the following is claimed:

1. A system for scheduling appointments, comprising:
first logic configured to receive a request for establishing an appointment; and
second logic configured to establish an appointment between a party who sent the request and a subject described in the request, wherein the appointment is established after the appointment is approved by the party who sent the request.

2. The system of claim 1, further comprising:
third logic configured to determine the subject based upon appointment criteria, the appointment criteria comprising criteria specified in the request.

3. The system of claim 2, wherein the appointment criteria further comprises criteria specified in an electronic profile of the party.

4. The system of claim 2, wherein the appointment criteria further comprises criteria specified in an electronic calendar of the party.

5. The system of claim 2, wherein the subject is determined based upon a type of service that the party wants the subject to perform.

6. The system of claim 2, wherein the third logic is configured to determine a time for the appointment based upon appointment criteria, the appointment criteria comprising criteria specified in the request and criteria specified in a electronic calendar of the party.

7. The system of claim 2, wherein the appointment criteria further comprises criteria specified in the electronic calendar of the subject.

8. The system of claim 1, further comprising:
logic configured to receive a report for a missed appointment and to charge a financial penalty against an account of a party that missed the appointment.

9. A method for establishing an appointment, comprising the steps of:
receiving a request, from a requesting party, for setting up an appointment with a subject, the request specifying characteristics of the appointment;
selecting a time at which the receiving party and the subject have available for the appointment;
temporarily recording the appointment for the subject;
prompting the requesting party to approve of the selected time; and
and upon receiving approval from the requesting party, permanently recording the appointment for the subject.

10. The method of claim 9, wherein the request describes criteria for selecting an unidentified subject for the appointment, and the method further comprises the step of:
selecting the subject for the appointment.

11. The method of claim 10, wherein the subject is determined based upon a description of a service that the requesting party wants the subject to perform.

12. The method of claim 9, further comprising the step of:
checking availability of the subject by examining a personal calendar of the subject.

13. The method of claim 12, further comprising the step of:
checking availability of the requesting party by examining a personal calendar of the receiving party in addition to criteria specified in the request.

14. The method of claim 9, further comprising the step of:
assessing a financial penalty to the requesting party if the requesting fails to honor the appointment that is established on behalf of the requesting party.

15. The method of claim 9, further comprising the step of:
specifying appointment criteria to consider in setting up the appointment, wherein at least a set of the appointment criteria is ranked in order that each should be considered in setting up the appointment relative to another.

16. A computer readable medium having a computer program for setting up an appointment, the program for performing the steps of:
receiving a request, from a requesting party, for setting up an appointment with a subject, the request specifying a purpose of the appointment;
selecting a time at which the receiving party and the subject have available for the appointment;
temporarily recording the appointment for the subject;
prompting the requesting party to approve of the selected time; and
and upon receiving approval from the requesting party, permanently recording the appointment for the subject.

17. The medium of claim 16, wherein the request describes criteria for selecting an unidentified subject for the appointment, and the program further comprises the step of:
selecting the subject for the appointment.

18. The medium of claim 17, wherein the subject is determined based upon a description of a service that the requesting party wants the subject to perform.

19. The medium of claim 16, further comprising the step of:
checking availability of the subject by examining a personal calendar of the subject.

20. The medium of claim 16, further comprising the step of:
assessing a financial penalty to the requesting party if the requesting fails to honor the appointment that is established on behalf of the requesting party.
